(19) United States
(12) Patent Application Publication
(10) Pub. No.: US 2024/0408940 A1
(43) Pub. Date: Dec. 12, 2024

(54) Air Outflow Device Comprising Walls With a Variable Shape, and Passenger Vehicle Equipped With Said Air Outflow Device

(71) Applicant: Bayerische Motoren Werke Aktiengesellschaft, Muenchen (DE)

(72) Inventor: Joern HOFHAUS, Freising (DE)

(21) Appl. No.: 18/704,512

(22) PCT Filed: Jan. 23, 2023
(86) PCT No.: PCT/EP2023/051477

§ 371 Date: Apr. 25, 2024

(30) Foreign Application Priority Data
Feb. 9, 2022 (DE) 10 2022 103 010.5

(51) Int. Cl. B60H 1/34

(52) U.S. Cl. CPC B60H 1/3414

(57) ABSTRACT

An air outflow device has a housing and an air duct which is formed between a first wall that has a variable shape and a second wall that has a variable shape and is arranged at a distance to the first wall. The first wall has a first section, which is pivotally mounted relative to the housing on the air duct outlet side, a second section, the downstream end of which is pivotally mounted on the first section, and a third section whose downstream side is pivotally mounted on the upstream end of the second section and whose upstream side is mounted on the air duct inlet side. The second wall has a fourth section, which is pivotally mounted relative to the housing on the air duct outlet side, a fifth section, the downstream end of which is pivotally mounted on the fourth section, and a sixth section whose downstream side is pivotally mounted on the upstream end of the fifth section and whose upstream side is mounted on the air duct inlet side. The first section, the third section, the fourth section, and the sixth section are each designed in the form of an individual lamella. The second section and/or the fifth section is made of at least one lamella.

### BACKGROUND AND SUMMARY

The present invention relates to an air vent and to a passenger vehicle equipped with the air vent.

US 2019/0301767 A1 discloses an air vent with a housing and with an air duct formed in the latter between a first wall and a second wall spaced apart from the first wall, in which the first wall and the second wall are designed to change shape by means of a membrane, in order to influence the direction and/or the speed of the air stream flowing out of the air vent into a vehicle interior of a passenger vehicle. According to the prior art document cited here, the shape of the membranes is changed by a lever mechanism in which the membranes lie exposed and are therefore disadvantageously unprotected against environmental influences.

It is therefore an object of the present invention to provide an air vent with walls that change shape, the adjustability of which air vent is improved and its service life extended.

This object is achieved by an air vent having the features of the independent claims. Specifically, this object is achieved by an air vent with a housing and with an air duct formed in the latter between a first wall and a second wall spaced apart from the first wall, the first wall and the second wall being designed to change shape. The air vent according to the invention is characterized by the following features:
(i) The first wall, at the air duct outlet side, i.e. in the region of the air vent from which the air flowing through it emerges in particular into a vehicle interior of a passenger vehicle, has a first section mounted pivotably with respect to the housing, a second section whose upstream end is mounted pivotably on the first section, and a third section which is pivotably mounted upstream on the downstream end of the second section and upstream at the air duct inlet side, i.e. in the region of the air vent in which the air enters.
(ii) The second wall, at the air duct outlet side, has a fourth section mounted pivotably with respect to the housing, a fifth section whose upstream end is mounted pivotably on the fourth section, and a sixth section which is pivotably mounted upstream on the downstream end of the fifth section and upstream at the air duct inlet side.
(iii) The first section, the third section, the fourth section and the sixth section are in each case formed as a single slat.
(iv) The second section and/or the fifth section is formed of at least one slat.

This advantageously results in a robust and reliably adjustable air vent of high variability, by means of which the flow direction of the air exiting or flowing out of it can be influenced in a simple manner by a suitable setting of an air guiding means.

According to a preferred embodiment, the third section, at the air duct inlet side, is mounted movably in translation in a first receptacle, and/or the sixth section, at the air duct inlet side, is mounted movably in translation in a second receptacle, which first receptacle or second receptacle is mounted pivotably, at the air duct inlet side, with respect to the housing. Advantageously, this further improves the adjustability of the aforementioned walls.

According to a further preferred embodiment, the first section, the slats of the second section, and the third section are connected to one another, at least in their respectively adjacent regions, by at least one first elastic connecting means. Alternatively or cumulatively, the fourth section, the slats of the fifth section, and the sixth section are connected to one another, at least in their respectively adjacent regions, by at least one second elastic connecting means. Advantageously, this further improves the adjustability of the aforementioned walls.

A particularly simple and reliable air vent that can be produced cost-effectively is advantageously obtained if the first connecting means and/or the second connecting means is designed as a membrane, on which at least one of the slats is injected.

According to an additional preferred embodiment of the air vent according to the invention, provision is made that the respective outer sides of two adjacent slats are convex to each other. In this way, during an adjustment of the respective walls, the mutually adjacent surfaces of two slats can as it were roll on each other, which advantageously has a positive effect on the adjustability and durability of the air vent.

The adjustment of two walls can advantageously be effected in that the first section has a first pivot axis downstream and/or the fourth section has a second pivot axis downstream. In other words, the first wall and the second wall are decoupled from each other in terms of their adjustment and can be adjusted separately from each other, but particularly preferably in a synchronous manner.

Alternatively, the two walls can advantageously be coupled to each other in terms of their adjustment if the first section and the fourth section have a common pivot axis positioned between them. In other words, the two walls are thus always adjusted simultaneously and with the same direction of rotation.

It will be noted that the air vent according to the invention can also have more than one air duct. In this case, one or each of the air ducts can be designed in accordance with the type disclosed above.

It is a further object of the present invention to make available a passenger vehicle having an alternative air vent compared to the prior art. This object is achieved by a passenger vehicle that has at least one air vent of the type disclosed above. The advantages mentioned above apply correspondingly.

It will be noted that one or more air vents according to the invention can be located at any suitable position in the passenger vehicle. Thus, provision can be made that an air vent of the type disclosed above is located in an instrument panel, a side shelf, a side cover, a pillar cover, a parcel shelf or the like. In this case, the air outlet opening can be spatially oriented in any suitable manner, in particular horizontally, vertically or in any other desired position with respect to a floor of the passenger vehicle.

A detailed, non-prejudicial, in particular non-restrictive description of exemplary embodiments of the present invention is given below with reference to the appended figures, which are not true to scale.

### BRIEF DESCRIPTION OF THE DRAWINGS

FIG. 1 shows a symbolically represented passenger vehicle, having an air vent according to an embodiment of the invention, partially represented in a perspective sectional view.

FIG. 2 is an enlarged sectional side view of a part of an air vent in three different operating positions.

FIG. 3 is an enlarged sectional side view of a part of an alternative air vent in three different operating positions.

### DETAILED DESCRIPTION OF THE DRAWINGS

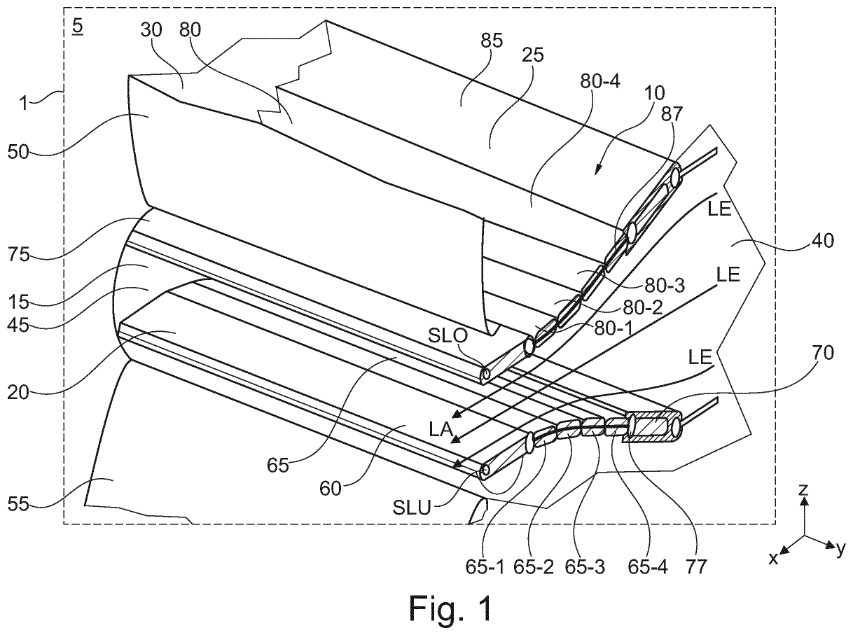

A passenger vehicle 1 is shown symbolically in FIG. 1, in the vehicle interior 5 of which an air vent 10 is arranged. According to the exemplary embodiment shown here, the air vent 10 is of a single-flow design. It therefore has one air duct 15 delimited in the vertical direction of the air vent 10 by a first wall 20, here a lower wall, and by a second wall 25, here an upper wall, which is spaced apart from the first wall 20. The air vent 10 has a housing 30 with an air inlet opening 40, which is shown on the right-hand side in FIG. 1 and through which an air stream delivered from an air-conditioning system or ventilation system (not shown here) located in the passenger vehicle 1 can flow into the first air inlet opening 40, as is symbolized by the arrows labeled “LE”. Downstream of the air inlet opening 40 there is an air outlet opening 45, through which the air LE that has entered leaves the air vent 10 in the direction of the vehicle interior 5, as is symbolized by the arrows labeled “LA”. Above and below the air outlet opening 45 are an upper trim panel 50 and a lower trim panel 55, respectively.

At the air duct outlet side, i.e. in the region of the air outlet opening 45, the first wall 20 has a first section 60 mounted pivotably with respect to the housing 30, a second section 65 whose downstream end is mounted pivotably on the first section 60, and a third section 70 which is pivotably mounted downstream on the upstream end of the second section 65 and upstream at the air duct inlet side, i.e. in the region of the air inlet opening 40. The first section 60 and the third section 70 are each basically formed of one slat. In the exemplary embodiment shown here, the second section 65 consists of four slats 65-1, 65-2, 65-3 and 65-4 which are arranged next to one another, i.e. serially one behind another in the longitudinal direction x of the air vent 10, and of which in each case two adjacent slats are mounted pivotably with respect to each other. The first section 60, the second section 65 or the slats 65-1, 65-2, 65-3 and 65-4, and the third section 70 are connected by a first elastic connecting means 77 which, according to this exemplary embodiment, is designed as a membrane. The first section 60, the second section 65 or the slats 65-1, 65-2, 65-3 and 65-4, and the third section 70 are injected onto this membrane. The respective outer sides of two adjacent slats 65-1, 65-2, 65-3 and 65-4 are convex to each other, being semicircular according to the exemplary embodiment shown here.

The second wall 25, at the air duct outlet side, i.e. in the region of the air outlet opening 45, has a fourth section 75 mounted pivotably with respect to the housing 30, a fifth section 80 whose downstream end is mounted pivotably on the fourth section 75, and a sixth section 85 which is pivotably mounted downstream on the upstream end of the fifth section 80 and upstream at the air duct inlet side, i.e. in the region of the air inlet opening 40. The fourth section 75 and the sixth section 85 are each basically formed of one slat. In the exemplary embodiment shown here, the fifth section 80 consists of four slats 80-1, 80-2, 80-3 and 80-4 which are arranged next to one another, i.e. serially one behind another in the longitudinal direction x of the air vent 10, and of which in each case two adjacent slats are mounted pivotably with respect to each other. The fourth section 75, the fifth section 80 or the slats 80-1, 80-2, 80-3 and 80-4, and the sixth section 85 are connected by a second elastic connecting means 87 which, according to this exemplary embodiment, is designed as a membrane. The fourth section 75, the fifth section 80 or the slats 80-1, 80-2, 80-3 and 80-4, and the sixth section 85 are injected onto this membrane. The respective outer sides of two adjacent slats 80-1, 80-2, 80-3 and 80-4 are convex to each other, being semicircular according to the exemplary embodiment shown here.

As can be seen from FIG. 1, the respective pivot axes (not shown individually for reasons of clarity) of the first section 60, of the second section 65 or the slats 65-1, 65-2, 65-3 and 65-4, of the third section 70, of the fourth section 75, of the fifth section 80 or the slats 80-1, 80-2 and 80-3, and of the sixth section 85 run substantially parallel to the y-axis. However, it will be noted that the air vent 10 can also be positioned in the motor vehicle 1 in a manner different from that shown in FIG. 1. For example, the housing 30 can be pivoted clockwise by 90° about the x-axis, even through this is not shown here, such that the first wall 20 would represent a right-hand wall and the second wall 25 would represent a left-hand wall in the air vent 10. In this case, the respective pivot axes of the first section 60, of the second section 65 or the slats 65-1, 65-2, 65-3 and 65-4, of the third section 70, of the fourth section 75, of the fifth section 80 or the slats 80-1, 80-2 and 80-3, and of the sixth section 85 are oriented substantially parallel to the z-axis.

As is shown in FIG. 1, the first wall 20 and the second wall 25 run toward each other, starting from the air inlet opening 40, in the direction of the air outlet opening 45, as a result of which the cross section of the air duct 15 narrows in the downstream direction. However, the air stream LE emerging from the air vent 10 is not deflected; rather, it flows substantially parallel to the x-axis.

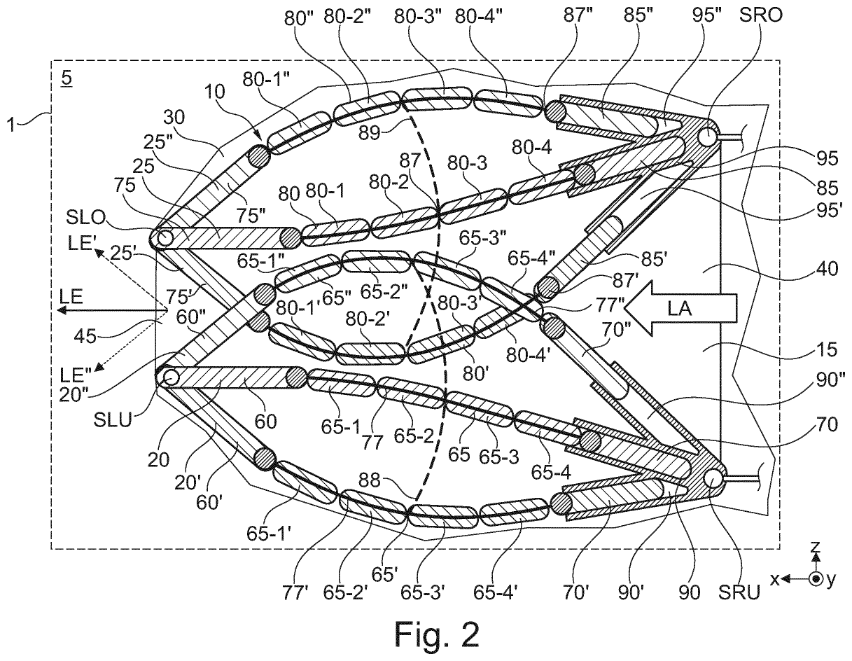

This can also be seen from FIG. 2, which shows a simplified sectional view of the air vent 10 in a first operating position, which corresponds to the view shown in FIG. 1 and in which the air stream LE leaves the air outlet opening 45 substantially parallel to the x-axis, in a second operating position, in which the air stream LE′ leaves the air outlet opening 45 upward in FIG. 2, and in a third operating position, in which the air stream LE″ leaves the air outlet opening downward in FIG. 2. Thus, according to the labeling chosen here, the same structural parts or elements have no index in the first operating position, have the index ′ in the second operating position, and have the index ″ in the third operating position.

In other words, it will be seen from FIG. 2 that the first wall 20′ and the second wall 25′ in the second operating position are substantially concave with respect to the x-axis and when viewed in the vertical direction, and the clear cross section of the air duct 15, starting from the air inlet opening 40, narrows in the direction of the air outlet opening 45. As a result, the air stream LE′ emerging from the air outlet opening 45 is accelerated and deflected upward in FIG. 2.

It will also be seen from FIG. 2 that the first wall 20″ and the second wall 25″ in the third operating position are substantially convex with respect to the x-axis and when viewed in the vertical direction, and the clear cross section of the air duct 15, starting from the air inlet opening 40, narrows in the direction of the air outlet opening 45. As a result, the air stream LE″ emerging from the air outlet opening 45 is accelerated and deflected downward in FIG. 2.

For the purpose of its adjustment, the first wall 20 is mounted about a first pivot axis SLU which runs substantially parallel to the y-axis and which is positioned in the region of the air outlet opening 45 and of the downstream end of the first section 60. Starting from the first operating position, the first wall 20 assumes the second operating position when the first section 60 is moved clockwise about the pivot axis SLU (cf. wall 20′). By contrast, when the first section 60, starting from the first operating position, is moved counterclockwise about the pivot axis SLU, the first wall 20 assumes the third operating position (cf. wall 20″).

For the purpose of guiding the first wall 20 in the z-direction, or in the vertical direction corresponding to the view chosen in FIG. 2, a first slotted guide 88 is provided which is located to the left or right of the housing 30 of the air vent 10, i.e. to the near side or far side of the paper plane of FIG. 2, and for reasons of clarity is shown only symbolically (and not shown in FIG. 1). The first slotted guide 88 has substantially the shape of an arc of a circle and is positioned in such a way that a guide means (not shown here) mounted on the left or right between the second slat 65-2 and the third slat 65-3 is able to move in the slotted guide 88.

For the purpose of its adjustment, the second wall 25 is mounted about a second pivot axis SLO which runs substantially parallel to the y-axis and which is positioned in the region of the air outlet opening 45 and of the downstream end of the fourth section 75. Starting from the first operating position, the second wall 25 assumes the second operating position when the fourth section 75 is moved clockwise about the pivot axis SLO (cf. wall 25′). By contrast, when the second section 75, starting from the first operating position, is moved counterclockwise about the pivot axis SLO, the second wall 25 assumes the third operating position (cf. wall 25″).

For the purpose of guiding the second wall 25 in the z-direction, or in the vertical direction corresponding to the view chosen in FIG. 2, a second slotted guide 89 is provided which is located to the left or right of the housing 30 of the air vent 10, i.e. to the near side or far side of the paper plane of FIG. 2, and for reasons of clarity is shown only symbolically (and not shown in FIG. 1). The second slotted guide 89 has substantially the shape of an arc of a circle and is positioned in such a way that a guide means (not shown here) mounted on the left or right between the sixth slat 80-2 and the seventh slat 80-3 is able to move in the slotted guide 89.

It goes without saying that the length of the first wall 20 and of the second wall 25 changes on account of changed radii of curvature when the respective operating positions are assumed. To permit the length compensation required here, provision can be made for the first connecting mechanism 77 and/or the second connecting mechanism 87 to be designed as elastic membranes, on which the first section 60, the slats 65-1, 65-2 and 65-3 of the second section, the third section and the fourth section 75, the slats 80-1, 80-2 and 80-3 of the fifth section, and the sixth section 85 are injected in such a way that their relative position to one another changes.

Alternatively or cumulatively, as is shown in FIG. 2, in the region of the air inlet opening 40 a first receptacle 90 can be provided which is designed like a sheath according to the exemplary embodiment shown here and in which the third section 70 is received in a longitudinally movable manner. The upstream end of the first receptacle 90 is mounted pivotably about a pivot axis SRU running substantially parallel to the y-axis, such that the first receptacle 90 can rotationally follow a movement of the first wall 20. Thus, the translationally movable third section 70 and the pivotably movable first receptacle 90 enable a movement of the first wall 20 to the second operating position (as symbolized by the index ′) and to the third operating position (as symbolized by the index ″) under improved aerodynamic conditions.

In a corresponding manner, as is shown in FIG. 2, in the region of the air inlet opening 40 a second receptacle 95 is provided which is designed like a sheath according to the exemplary embodiment shown here and in which the sixth section 85 is received in a longitudinally movable manner. The upstream end of the second receptacle 95 is mounted pivotably about a pivot axis SRO running substantially parallel to the y-axis, such that the second receptacle 95 can rotationally follow a movement of the second wall 25. Thus, the translationally movable sixth section 85 and the pivotably movable second receptacle 95 enable a movement of the second wall 25 to the second operating position (as symbolized by the index ′) and to the third operating position (as symbolized by the index ″) under improved aerodynamic conditions.

As can be seen from FIG. 2, the distance between the first section 60 and the fourth section 75 changes in the respective operating positions, as a result of which different exit speeds of the air streams LE, LE′ and LE″ are made possible depending on the operating positions.

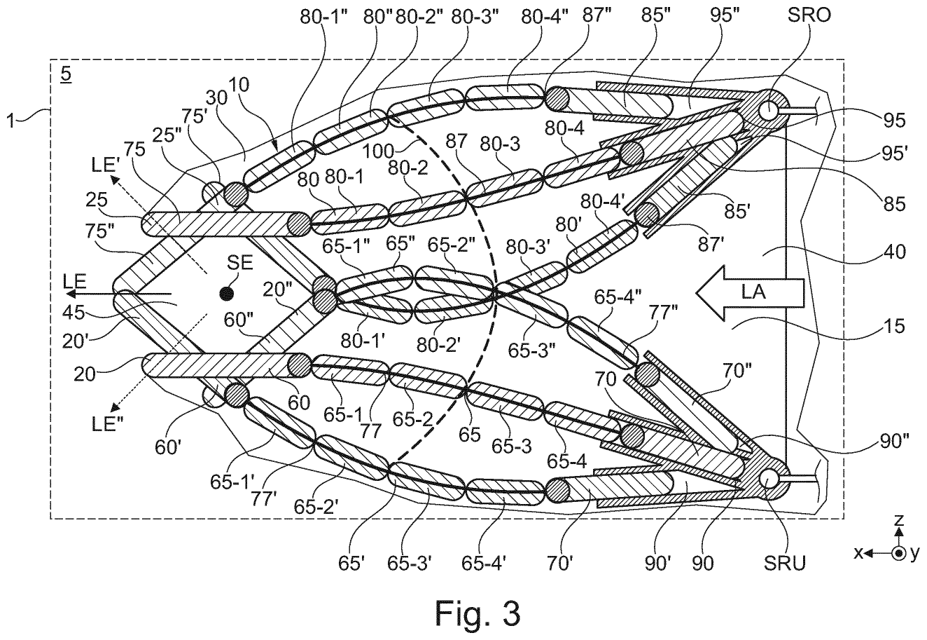

An alternative embodiment to the embodiment shown in FIG. 2 is shown in FIG. 3, which illustrates a simplified sectional view of the air vent 10 in a first operating position (without index), in a second operating position (as symbolized by the index ′), and in a third operating position (as symbolized by the index ″). The embodiment according to FIG. 3 differs from the embodiment of the air vent 10 shown in FIG. 2 in that the two pivot axes SLU and SLO provided on the first section 60 and on the fourth section 75 are now combined into a single virtual pivot axis SE, which is oriented substantially parallel to the y-axis and which is located substantially centrally between the first section 60 and the fourth section 75 and, viewed upstream, at the middle of the length of the first section 60 and of the fourth section 75 in the first operating position.

In contrast to the embodiment shown in FIG. 2, the design of the air vent 10 shown in FIG. 3, with just a single pivot axis SE, makes it possible to provide just a single slotted guide 100 to the left or right of the housing 30 of the air vent 10, i.e. to the near side or far side of the paper plane of FIG. 3. For reasons of clarity, the slotted guide 100 is shown only symbolically (and not shown in FIG. 1). It has substantially the shape of an arc of a circle and is positioned in such a way that a guide means (not shown here) mounted on the left or right between the second slat 65-2 and the third slat 65-3 or a guide means mounted on the left or right between the sixth slat 80-2 and the seventh slat 80-3 is able to move in the slotted guide 100. The first wall 20 and the second wall 25 are thus adjustable in a guided manner.

As can be seen from FIG. 3, the distance between the first section 60 and the fourth section 75 remains the same in all operating positions, as a result of which a constant exit speed of the respective air streams LE, LE′ and L″ is made possible.

It goes without saying that the first, second and third operating positions shown in FIGS. 1 to 3 are only given as examples and that the lower wall 20 or upper wall 25 can in particular also assume any suitable intermediate position. It will also be noted that the number of the sections and/or slats provided according to the invention can deviate from the number according to the embodiments set out above.

### LIST OF REFERENCE SIGNS

1 passenger vehicle
5 vehicle interior
10 air vent
15 air duct
20 first wall
25 second wall
30 housing
40 air inlet opening
45 air outlet opening
50 upper trim panel
55 lower trim panel
60 first section (first operating position)
60′ first section (second operating position)
60″ first section (third operating position)
65 second section (first operating position)
65′ second section (second operating position)
65″ second section (third operating position)
65-1 slat (first operating position)
65-1′ slat (second operating position)
65-1″ slat (third operating position)
65-2 slat (first operating position)
65-2′ slat (second operating position)
65-2″ slat (third operating position)
65-3 slat (first operating position)
65-3′ slat (second operating position)
65-3″ slat (third operating position)
65-4 slat (first operating position)
65-4′ slat (second operating position)
65-4″ slat (third operating position)
70 third section (first operating position)
70′ third section (second operating position)
70″ third section (third operating position)
75 fourth section (first operating position)
75′ fourth section (second operating position)
75″ fourth section (third operating position)
77 first connecting mechanism (first operating position)
77′ first connecting mechanism (second operating position)
77″ first connecting mechanism (third operating position)
80 fifth section (first operating position)
80′ fifth section (second operating position)
80″ fifth section (third operating position)
80-1 slat (first operating position)
80-1′ slat (second operating position)
80-1″ slat (third operating position)
80-2 slat (first operating position)
80-2′ slat (second operating position)
80-2″ slat (third operating position)
80-3 slat (first operating position)
80-3′ slat (second operating position)
80-3″ slat (third operating position)
80-4 slat (first operating position)
80-4′ slat (second operating position)
80-4″ slat (third operating position)
85 sixth section (first operating position)
85′ sixth section (second operating position)
85″ sixth section (third operating position)
87 second connecting mechanism (first operating position)
87′ second connecting mechanism (second operating position)
87″ second connecting mechanism (third operating position)
88 first slotted guide
89 second slotted guide
90 first receptacle
95 second receptacle
100 slotted guide
LA air stream (air duct inlet side)
LE air stream (air duct outlet side) in a first operating position
LE′ air stream (air duct outlet side) in a second operating position
LE″ air stream (air duct outlet side) in a third operating position
SE pivot axis
SLO pivot axis
SLU pivot axis
SRO pivot axis
SRU pivot axis
x,y,z coordinates of a Cartesian coordinate system as per ISO 4130-1978

1-8. (canceled)

9. An air vent, comprising:
a housing; and
an air duct formed in the housing between a first wall and a second wall spaced apart from the first wall, the first wall and the second wall being designed to change shape, wherein
the first wall, at an air duct outlet side, has a first section mounted pivotably with respect to the housing, a second section whose downstream end is mounted pivotably on the first section, and a third section which is pivotably mounted downstream on the upstream end of the second section and upstream at an air duct inlet side,
the second wall, at the air duct outlet side, has a fourth section mounted pivotably with respect to the housing, a fifth section whose downstream end is mounted pivotably on the fourth section, and a sixth section which is pivotably mounted downstream on the upstream end of the fifth section and upstream at the air duct inlet side,
the first section, the third section, the fourth section and the sixth section are in each case formed as a single slat, and
the second section and/or the fifth section is formed of at least one slat.

10. The air vent according to claim 9, wherein
the third section, at the air duct inlet side, is mounted movably in translation in a first receptacle, and/or
the sixth section, at the air duct inlet side, is mounted movably in translation in a second receptacle,
wherein the first receptacle or second receptacle is mounted pivotably, at the air duct inlet side, with respect to the housing.

11. The air vent according to claim 9, wherein
the first section, the slats of the second section, and the third section are connected to one another, at least in their respectively adjacent regions, by at least one first elastic connecting mechanism, and/or
the fourth section, the slats of the fifth section, and the sixth section are connected to one another, at least in their respectively adjacent regions, by at least one second elastic connecting mechanism.

12. The air vent according to claim 11, wherein
the first connecting mechanism and/or the second connecting mechanism is designed as a membrane, on which at least one of the slats is injected.

13. The air vent according to claim 9, wherein
respective outer sides of two adjacent slats are convex to each other.

14. The air vent according to claim 9, wherein
the first section has a first pivot axis downstream, and/or
the fourth section has a second pivot axis downstream.

15. The air vent according to claim 9, wherein
the first section and the fourth section have a common pivot axis positioned between them.

16. A passenger vehicle comprising at least one air vent according to claim 9.
